(19) United States
(12) Patent Application Publication
(10) Pub. No.: US 2019/0136578 A1
(43) Pub. Date: May 9, 2019

(54) Combination Locking Device, Apparatus and Method

(71) Applicant: Wireless Energy Industries Pty Ltd, Tinbeerwah (AU)

(72) Inventors: Ben Mandeville-Clarke, Tinbeerwah (AU); Danum Harris-Lusk, Tewantin (AU)

(73) Assignee: Wireless Energy Industries Pty Ltd, Tinbeerwah (AU)

(21) Appl. No.: 15/528,509

(22) PCT Filed: Nov. 10, 2016
(86) PCT No.: PCT/AU2016/000377

§ 371 Date: May 21, 2017

(30) Foreign Application Priority Data
Jun. 30, 2016 (AU) 2016902587

(51) Int. Cl. E05B 37/02; E05B 37/00; E05B 37/10

(52) U.S. Cl. CPC E05B 37/025; E05B 67/02; E05B 37/10; E05B 37/0072

(57) ABSTRACT

The present disclosure describes a combination-locking device comprising a locking body, a locking mechanism, and plurality of perceptibly identifiable entertainment media character picture representations substantially disposed on a portion of a plurality of human-interactive rotatable wheels. The plurality of perceptibly identifiable entertainment media character picture representations is operable to be arranged by a user in an at least one unique combination or sequence in order to facilitate the detachment of the locking mechanism from the locking body in an at least one location. The unique sequence or combination of perceptibly identifiable entertainment media character picture representations operable to facilitate separation of the locking mechanism from the locking body in the at least one location may be user-inputted via rotation of the plurality of rotatable wheels, or user-inputted via an electronics device comprising a suitable user-interfacing means substantially coupled to the combination locking device.

### CROSS-REFERENCE TO RELATED APPLICATION

This application claims the benefit of Australian Provisional Patent Application Serial No. 2016902587, filed on Jun. 30, 3016, the contents of which are herein incorporated by reference in their entirety.

### FIELD OF THE INVENTION

The present invention relates to combination locking devices, and specifically combination locking devices having perceptibly identifiable entertainment media character representations as the system, process and method for unlocking the combination lock.

### BACKGROUND OF THE INVENTION

Locks are commonly used for securing a wide variety of objects. Combination locks are a popular form of locking device, due to the fact that an external key is not required. An external key has the disadvantage of being easily displaced, resulting in significant inconvenience to the owner or user of the locking device. Many combination-locking devices are either single dial or multi-dial number or word-based combinations. In a first example, to substantially separate the locking mechanism from the locking body, the sequence of numbers “7, 12, 9” may need to be known and inputted by the user as appropriate to the particular type of combination locking device. In a second example, to substantially separate the locking mechanism from the locking body, the letter combination “B, L, U, E” may need to be known and inputted by the user as appropriate to the particular type of combination locking device. Single and multi-dial combination locking devices utilizing textual and/or number-based combinations to facilitate substantially separating the locking mechanism from the locking body are well known in the art. Examples are U.S. Patent Application Publication No. 2008/0053167 to Basche, and U.S. Patent Application Publication No. 2011/0209506 to Johnson et al.

Entertainment media, such as books, comics, television shows, movies, video games, and the like form a significant part of many people's lives, with a particular emphasis on children, tweens, and teenagers. Entertainment media franchises, such as Star Wars, Lord of the Rings, Halo, Batman, Game of Thrones, and the like, successfully extend their commercial franchising scope to include merchandise, such as t-shirts, toys, and board games. In many cases, revenues accruing to the franchise owners from the totality of merchandise sales are more significant than revenues accruing from sales of the franchise entertainment media.

Entertainment media franchise owners and their licensees are constantly searching for further merchandising opportunities to increase revenues. Entertainment media franchise owners and their licensees understand that maintaining strong revenue growth requires commercialising new and unique products comprising aspects of the entertainment media franchise on a regular basis. Entertainment media franchise owners and their licensees further understand that children's products comprising aspects of the entertainment media franchise will sell particularly well before and during holiday seasons. Many entertainment media franchises comprise a large variety of characters (such as Yoda, Darth Vader, the many Batman villains, and the like) from which to create and commercialise a large variety of merchandising characters.

Combination locking devices are used to secure a wide variety of children's objects, including bicycles, skateboards, roller-blades, secret diaries, school lockers, money-containing piggy banks, confectionary dispensers, desk drawers, cupboard drawers, and the like. By including perceptibly identifiable entertainment media character representations for a particular entertainment media franchise in a substantial capacity in a combination-locking device, owners and licensees for a particular entertainment media franchise will be positioned to capitalize upon a significant additional revenue stream.

### SUMMARY OF THE INVENTION

The present disclosure overcomes challenges and limitations of the prior art and provides additional benefits. A brief summary of several embodiments and aspects of the invention are presented. Thereafter, a detailed description of the illustrated embodiments is presented, which will permit one skilled in the relevant art to understand, make and use the invention. One skilled in the art can obtain a full appreciation of aspects of the invention from the subsequent detailed description, read together with the Figures, and from the Claims, which follow the Detailed Description.

In a preferred embodiment of the present invention, a multi-dial combination-locking device is presented. The combination-locking device comprises a body, a locking mechanism coupled to the body, and a plurality of rotatable wheels able to be rotated between a locked position wherein the locking mechanism is locked relative to the respective wheel, and an unlocked position wherein the locking mechanism is unlocked relative to the respective wheel. Each wheel comprises a plurality of separate and distinct perceptibly identifiable entertainment media character picture representations, wherein each perceptibly identifiable entertainment media character picture representation is disposed upon an at least a portion of the wheel's surface. In combination, an at least a portion of the plurality of wheels comprising an at least a portion of the plurality the perceptibly identifiable entertainment media character picture representations are configured to display a first row of perceptibly identifiable entertainment media character picture representations relative to the body. A non-limiting example combination or sequence of perceptibly identifiable entertainment media character picture representations operable to facilitate an unlocked position, wherein the locking mechanism is unlocked relative to the respective wheel from the Star Wars franchise comprises: “Yoda, Chewbacca, Darth Vader, Han Solo”. Those with skill in the art will readily be able to use common methods of searching, such as via navigating to the official Star Wars online website, to view the perceptibly identifiable entertainment media character picture representations for Yoda, Chewbacca, Darth Vader, Han Solo, and the like.

In another embodiment of the present invention, a single-dial combination-locking device is presented. The combination-locking device comprises: (1) a body; (2) a plurality of wheels with each wheel comprising a notch; (3) a bar coupled to the plurality of wheels such that at particular instances in time the bar is inserted into all notches simultaneously—the action of which will allow the combination-locking device to be uncoupled from an at least one object it was previously serving its function of locking; (4) a human-interactive dial comprising a plurality of perceptibly identifiable entertainment media character picture representations disposed upon an at least a portion of the dial's surface; (5) a spindle coupled to at least a portion of the plurality of wheels. In combination, (1), (2), (3), (4), and (5) comprises a locking mechanism operatively coupled to the body. The human-interactive dial enables a user to select a unique combination or sequence of perceptibly identifiable entertainment media character representations, the unique combination of which will enable the bar coupled to the plurality of wheels to be simultaneously inserted into all notches, and hence facilitate the locking device to become uncoupled from an at least one object it was previously serving its function of locking. A non-limiting example combination or sequence of perceptibly identifiable entertainment media character picture representations operable to facilitate an unlocked position from the Game of Thrones franchise comprises: “Jon Snow, Jaime Lannister, Rob Stark”. Those with skill in the art will readily be able to use common methods of searching, such as via navigating to the official Game of Thrones online website, to view the perceptibly identifiable entertainment media character picture representations for Jon Snow, Jaime Lannister, Rob Stark, and the like.

In yet a further embodiment of the present invention, an electronics device with an appropriate user-interfacing means enables an appropriate user to select, input, or manipulate a sequence or a combination of perceptibly identifiable entertainment media character picture representations in order to facilitate the unlocking mechanism of the combination-lock.

A preferred method of manufacture for the present invention is also presented. The preferred method of manufacture comprises the steps of: (1) determining a plurality of perceptibly identifiable entertainment media character picture representations to be displayed by the locking device; (2) disposing a plurality of rotatable wheels at least partially within the locking device; (3) disposing a plurality of perceptibly identifiable entertainment media character picture representations on at least a portion of the surface of an at least one rotatable wheel; and (4) arranging the plurality of rotatable wheels in a first position wherein in the first position an at least one of the plurality of rotatable wheels displays to a human perceiver an at least one perceptibly identifiable entertainment media character picture representation.

### BRIEF DESCRIPTION OF THE DRAWINGS

Further features and advantages of the invention will become apparent from the following detailed description made with reference to the accompanying drawings, wherein:

FIG. 1 is a perspective view of a combination-locking device comprising a plurality of perceptibly identifiable entertainment media character picture representations, in accordance with a main embodiment of the present invention;

FIG. 2 is a schematic front-view of a customizable perceptibly identifiable entertainment media character picture representation combination-locking device, in accordance with a main embodiment of the present invention;

FIG. 3 is a block diagram of a representative table illustrating perceptibly identifiable entertainment media character picture representation positions of the plurality of wheels in accordance with embodiments of the present invention;

FIG. 4 is a schematic front-view of a combination-locking device comprising a plurality of perceptibly identifiable entertainment media character picture representations, in accordance with an embodiment of the present invention;

FIG. 5a is an example embodiment schematic side-view of the main aspects of a typical single-dial combination-locking device comprising a plurality of perceptibly identifiable entertainment media character picture representations;

FIG. 5b is an example embodiment front-view of a typical single-dial combination-locking device comprising a plurality of perceptibly identifiable entertainment media character picture representations;

FIG. 6a is a schematic front-view of a combination-locking device incorporating perceptibly identifiable entertainment media character picture representations in accordance with an example embodiment of the present invention;

FIG. 6b is a schematic front-view of a combination-locking device incorporating perceptibly identifiable entertainment media character picture representations in accordance with an example embodiment of the present invention;

FIG. 6c is a schematic front-view of a combination-locking device incorporating perceptibly identifiable entertainment media character picture representations in accordance with an example embodiment of the present invention;

FIG. 7 shows an alternative embodiment of the present invention comprising an electronics device with a user-interfacing means for selecting a combination of perceptibly identifiable entertainment media character picture representations to facilitate the combination-lock unlocking mechanism.

### DETAILED DESCRIPTION OF THE PREFERRED EMBODIMENTS

In the following detailed specification, “perceptibly identifiable entertainment media character picture representations” refers to one or more readily identifiable characters from one or more popular entertainment media franchises, wherein the one or more entertainment media franchises may derive from one or more of: novel, novel series, e-book, fiction, hard-copy book, television series, audio book, animation, movie, movie series, game, game series, digital game series, non-fiction, non-fiction series, or any other consumer entertainment medium comprising a plurality of story-characters. Non-limiting examples of characters, which may form the basis for character picture representations, are Mickey Mouse, Darth Vader, Harry Potter, Shrek, and Winnie the Pooh. Non-limiting examples of entertainment media franchises are Star Trek, Shrek, Ice Age, and Lord of the Rings.

Entertainment media character picture representation combination locks, including character picture representation combination locks based upon popular entertainment media franchises, are described in detail herein in accordance with embodiments of the present invention. Entertainment media character picture representation combination locks include, but are not limited to, locks for securing bicycles, skateboards, roller blades, four wheeled travel apparatuses, children's money-holding containers, confectionary dispensers, lockers, bags, gates, secret diaries, desk drawers, doors, and the like. In the following description, numerous specific details are discussed to provide a thorough and enabling description for the embodiments of the invention. One skilled in the relevant art, however, will recognize that the invention can be practiced without one or more of the specific details. In other instances, well-known structures or operations are not shown, or are not described in detail to avoid obscuring aspects of this invention. In general, alternatives and alternate embodiments described herein are substantially similar to the previously described embodiments, and common elements are identified by the same reference numbers.

In other embodiments, the combination may comprise perceptibly identifiable entertainment media character picture representations from a plurality of unique entertainment media franchises, such as, but not limited to, Star Wars, Superman, The Avengers, Shrek, Halo, Pokemon, and the like.

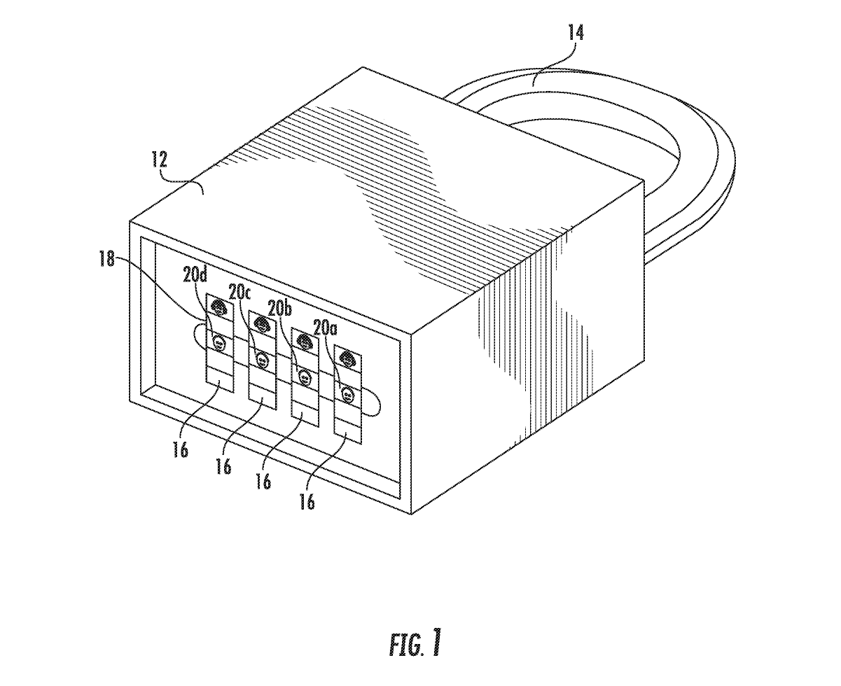

Turning now to FIG. 1, a perspective view of an exemplary combination-locking device 10 is presented. The exemplary combination-locking device 10 comprises a body 12, a shackle 14 with an at least one consistent attachment to an aspect of the body 12, and a plurality of wheels 16 partially exposed through openings 18 in the body 12 to enable human-interaction with the wheels 16. Additional wheels (not shown) may be disposed upon or within aspects of the body 12 to facilitate rotation of wheels 16 via human-interaction, where necessary. Disposed upon the wheels 16 is a plurality of perceptibly identifiable entertainment media character picture representations 20a, 20b, 20c, 20d. Each entertainment media character picture representation is preferably a well-known entertainment media character from an entertainment media franchise such as, but not limited to, Star Wars, Batman, Barbie, Game of Thrones, and the like. As a non-limiting example, combination-locking device 10 may be a Star Wars franchise combination-locking device, with 20a showing a commonly understood picture representation of Yoda, 20b showing a commonly understood picture representation of Chewbacca, 20c showing a commonly understood picture representation of Darth Vader, and 20d showing a commonly understood picture representation of Han Solo. 20a, 20b, 20c, 20d may comprise the unique user or manufacturer defined combination required to separate the shackle 14 from the body 12 in at least one location, may comprise a first position combination shown to the user upon point-of-purchase, may comprise only a portion of the totality of perceptibly identifiable entertainment media picture representations required to separate the shackle 14 from the body 12 in the at least one location, and the like. The materialistic composition of the shackle 14 is a durable and high-tensile strength material, such as stainless steel, and this along with other material types are well known in the art. The materialistic composition of the body 12 is a durable and high-tensile strength material, such as stainless steel, and this along with other material types are well known in the art.

In some embodiments, the body 12 may be physically structured to be perceptibly identifiable as a two-dimensional or three-dimensional commonly understood representation of a character from an entertainment media franchise, wherein the character-shaped body 12 may align with the entertainment media franchise depicted on the wheels 16. In a non-limiting example, the entertainment media character-shaped body 12 may be Batman.

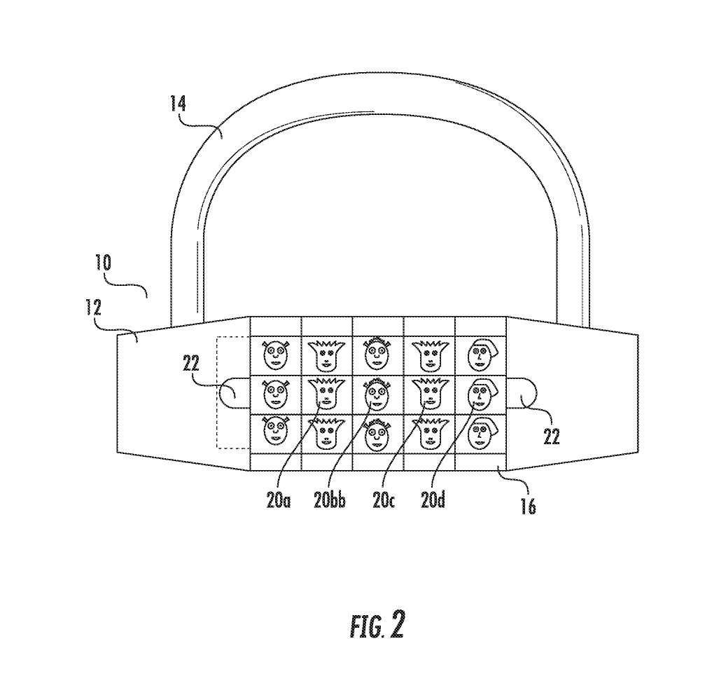

Turning now to FIG. 2, a front-view embodiment of the present invention 10 is depicted. Shown is the body 12, the shackle 14, the plurality of wheels 16, and the plurality of perceptibly identifiable entertainment media character picture representations 20a, 20b, 20c, 20d as has been previously detailed and described. In the embodiment of FIG. 2, a combination position indicator 22 is depicted. The combination position indicator 22 is located proximate to the wheels 16. In some embodiments, the combination position indicator 22 identifies to a user where to position the wheels 16 that have selected perceptibly identifiable entertainment media character picture representations that correspond to the correct unique combination of the locking device 10. When the correct unique combination of perceptibly identifiable entertainment media character picture representations is positioned in alignment with the indicator 22, the shackle 14 can be substantially separated from the body 12 in an at least one position. Other uses of the indicator 22, including dimensional and positional change will be well known to those with skill in the art.

The wheels 16 are axially aligned with each other and with the body 12. In some embodiments, only a single row, in relation to the body 12, of perceptibly identifiable entertainment media character representations are shown to the user. For example, 20a, 20b, 20c, 20d. In other embodiments, including the illustrated embodiment, a plurality of rows, in relation to the body 12, of perceptibly identifiable entertainment media character representations are shown to the user. In some embodiments comprising the plurality of rows, the user may be required to input the correct combination of perceptibly identifiable entertainment media character representations for each row in order to substantially separate the shackle 14 from the body 12 in the at least one location. In some embodiments comprising the plurality of rows, the user may only be required to select the correct combination of perceptibly identifiable entertainment media character representations for a single row in order to substantially separate the shackle 14 from the body 12 in the at least one location. In the illustrated embodiment, which is a non-limiting example, the user is only required to select the correct combination of perceptibly identifiable entertainment media character representations for a single row in order to substantially separate the shackle 14 from the body 12 in the at least one location; the single row being the row in direct alignment with the positional indicator 22 and comprising 20a, 20b, 20c, 20d.

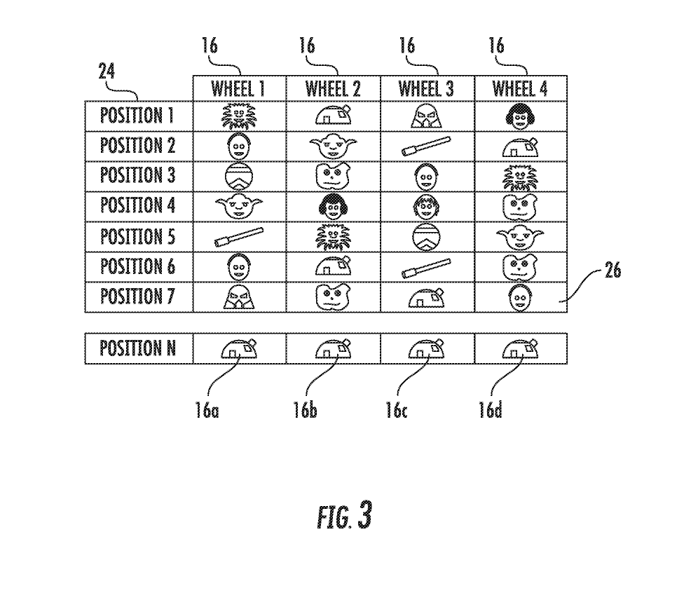

FIG. 3 is a schematic diagram of a representative table illustrating perceptibly identifiable entertainment media character representations disposed upon the wheels 16 in accordance with some embodiments of the present invention. In some embodiments, the table 24 shows a combination-locking device having five wheels 16 as shown by the wheel columns 16a-16d, but any number of wheels may be substituted as the application requires. Each wheel has a plurality of perceptibly identifiable entertainment media character picture representation positions 26 for displaying one perceptibly identifiable entertainment media character picture representation in each position 26. In this embodiment, each wheel 16 can display seven unique positions to the user either simultaneously or separately. In other embodiments, each wheel 16 may display more or less unique positions to the user either simultaneously or separately, as indicated by Position n.

In some embodiments, each wheel 16 may comprise a plurality of unique perceptibly identifiable entertainment media character picture representations, or may comprise a plurality of perceptibly identifiable entertainment media character picture representations, wherein a portion of the plurality are duplicates. In some embodiments, the plurality of wheels 16 may comprise a plurality of perceptibly identifiable entertainment media character picture representations from a first entertainment media franchise, such as Winnie the Pooh. In some embodiments, the plurality of wheels 16 may comprise a plurality of perceptibly identifiable entertainment media character picture representations from both a first entertainment media franchise, such as Star Wars, and a second entertainment media franchise, such as Batman.

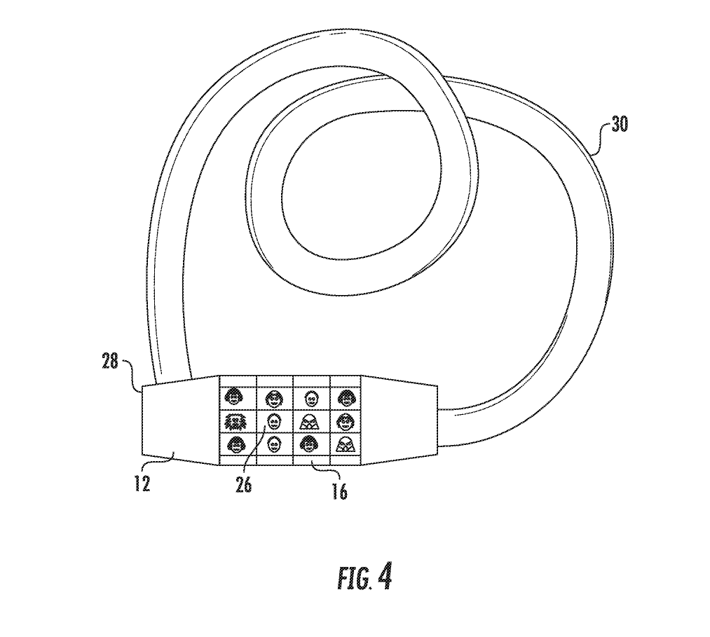

FIG. 4 is a schematic, front-view of an alternative embodiment of a combination-locking device comprising perceptibly identifiable entertainment media character picture representations 28. FIG. 4 is substantially similar to FIGS. 1 and 2, with the main difference in this embodiment being a shackle 30 comprising substantially flexible cable. Shackle 30 has the advantage of being applied to large objects, including transport mediums such as bicycles and skateboards. In this embodiment, the plurality of wheels 16 displays to the user a plurality of positions comprising perceptibly identifiable entertainment media character picture representations 26. In some embodiments, the user may be required to line up a single row of perceptibly identifiable entertainment media character picture representations in a predetermined correct combination in relation to the body 12 in order to substantially separate the shackle 30 from the body 12 in an at least one location. In some embodiments, the user may be required to line up multiple rows of perceptibly identifiable entertainment media character picture representations in a predetermined correct combination in relation to the body 12 in order to substantially separate the shackle 30 from the body 12 in the at least one location. In further embodiments, the user may be required to line up one or more vertical columns of perceptibly identifiable entertainment media character picture representations in a predetermined correct combination in relation to the body 12 in order to substantially separate the shackle 30 from the body 12 in the at least one location.

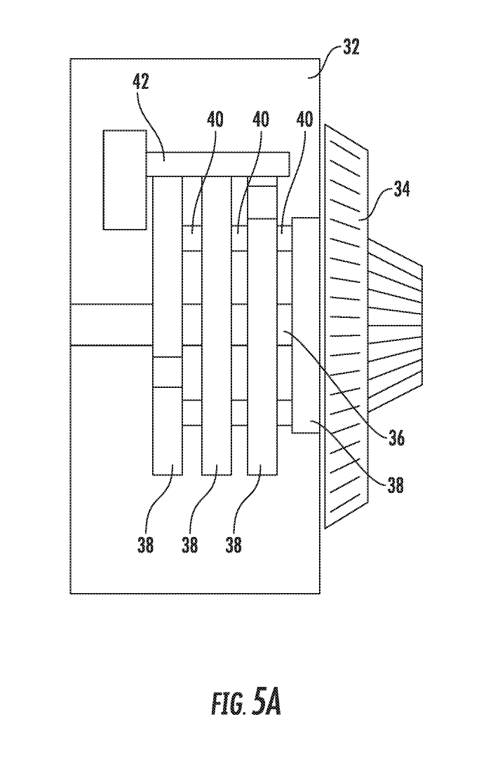

FIG. 5a is an example embodiment schematic side-view of the main aspects of a typical single-dial combination-locking device 32 to provide clarity to the present invention. A human-interactive dial 34 is attached to a spindle 36, which in turn is attached to a plurality of wheels 38. The plurality of wheels 38 each comprises the distinguishing feature of a notch 40 and the plurality of wheels 38 are able to be rotated about the spindle 36. At certain instances in time, the notches 40 are able to be aligned such that a bar 42 is able to be inserted into each notch 40 and retain the insertion into each notch 40 substantially simultaneously. Alignment of the notches 40 in this configuration is facilitated via user-input via the human-interactive dial 34 wherein the user-input comprises a correct combination to facilitate the unlocking mechanism. Those with skill in the art will be able to readily understand and derive additional elements and methods involving a typical single-dial combination-locking device. For reference, such non-limiting additional descriptions may be found in U.S. Patent Application Publication No. 2011/0209506 to Johnson et al.

FIG. 5b is an example embodiment schematic front-view of the single-dial combination-locking device 32 incorporating the perceptibly identifiable entertainment media character picture representations of the present invention. Single-dial combination-locking device 32 comprises a body 44, a shackle 46 and the human-interactive dial 34. The purposes and functions of each of these elements have been described elsewhere in this specification. Disposed upon aspects of the surface of the dial 34 is a plurality of perceptibly identifiable entertainment media character picture representations, of which 20a, 20b, 20c, 20d are non-limiting examples.

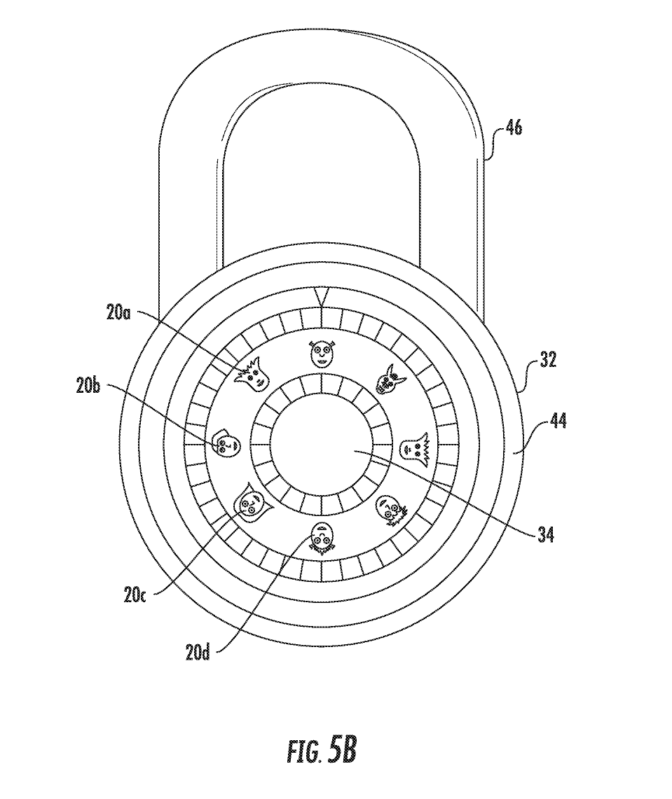

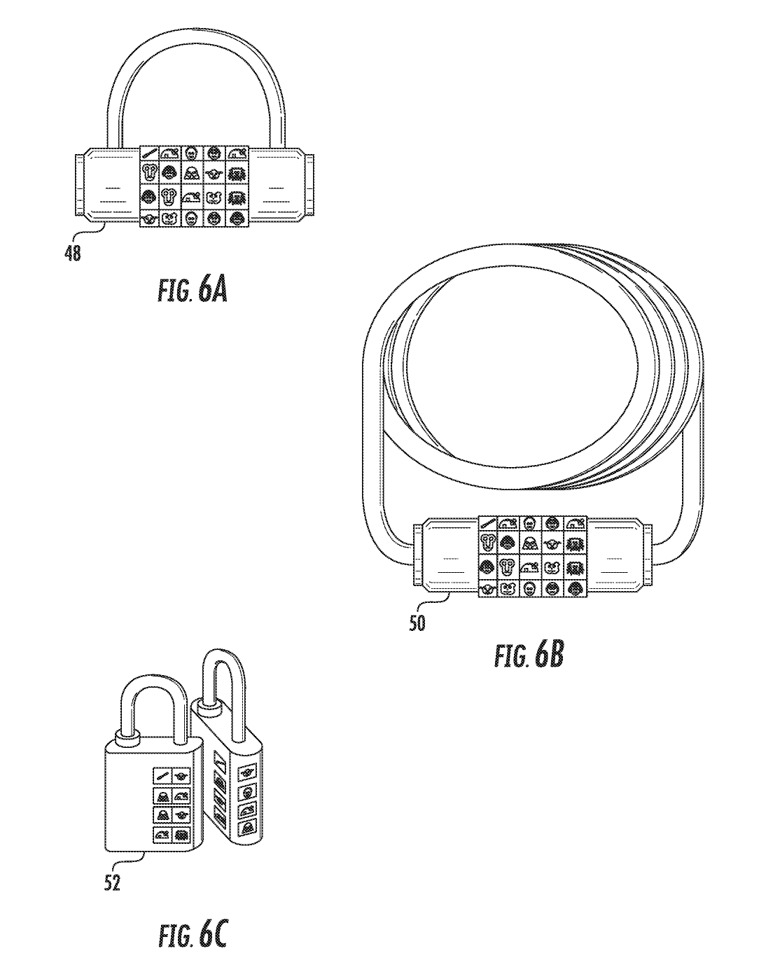

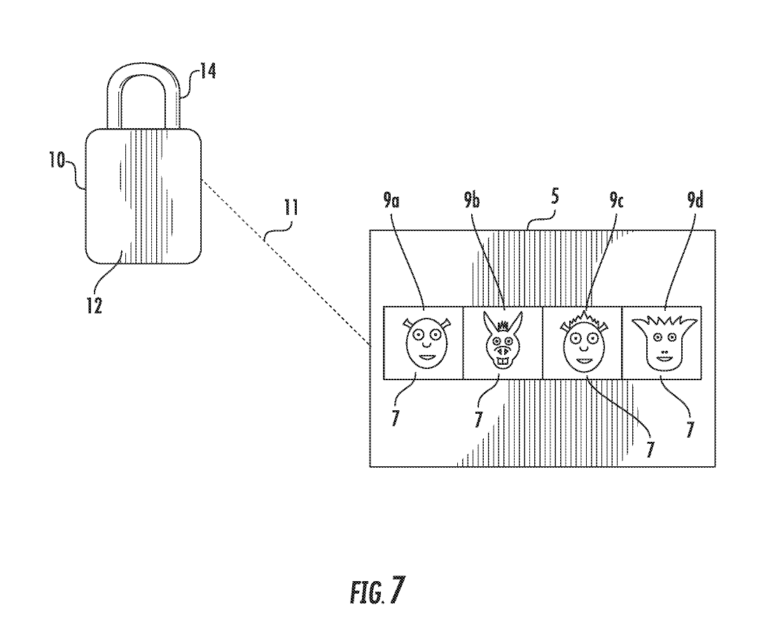

FIGS. 6a, 6b and 6c are schematic front-views of combination-locking devices incorporating perceptibly identifiable entertainment media character picture representations in accordance with example embodiments of the present invention. FIG. 6a depicts a perceptibly identifiable entertainment media character picture representation combination-locking travel lock 48. FIG. 6b depicts a perceptibly identifiable entertainment media character picture representation combination-locking bicycle lock 50. FIG. 6c depicts a perceptibly identifiable entertainment media character picture representation combination-locking padlock 52.

FIG. 7 depicts an alternative embodiment of the present invention comprising an electronics means of selecting a combination of perceptibly identifiable entertainment media character picture representations to facilitate the combination-lock unlocking mechanism. In the embodiment, a screen 5 is depicted. The screen 5 is preferably user-interactive via a touch-screen, or a connected peripheral electronics device (not shown) such as, but not limited to, keypad, microphone, motion-sensor device, audio input device and the like. The screen 5 comprises a plurality of positions 7 wherein each respective position 7 may comprise a perceptibly identifiable entertainment media character picture representation 9a, 9b, 9c, 9d, respectively. In this non-limiting embodiment, 9a refers to a picture representation of Mickey Mouse; 9b refers to a picture representation of Max Goof; 9c refers to a picture representation of Pete; 9d refers to a picture representation of Roxanne. To select the correct combination of perceptibly identifiable entertainment media character picture representations, the user may be able to scroll up, down, left, right for each position 7, or drag and drop the correct combination of perceptibly identifiable entertainment media character picture representation into each position 7 from an original starting position (not shown). Those with skill in the art will readily recognize any number of variations or additional methods for selecting and/or inputting the correct combination of perceptibly identifiable entertainment media character picture representations. In this embodiment, positions 7 comprise a single row and five columns (not shown in full) with relation to the screen 5; however, alternative embodiments may readily incorporate positions 7 across a plurality of rows and columns, as the application requires. Screen 5 is coupled to the combination-locking device 10 via one or more electronics circuits (not shown in the main), as those with skill in the art of electronics-based locks will readily know and understand. These electronics circuits may comprise wired or wireless links, or a combination of wired and wireless links. In this non-limiting embodiment, screen 5 is electronically coupled to the combination-locking device via a wireless link 11, which may be, but is not limited to, IEEE 802.11x, Bluetooth, ZigBee, cellular network, satellite link, and the like. In this non-limiting embodiment, the correct combination of 9a, 9b, 9c, 9d being selected or otherwise inputted by the user facilitates the shackle 14 being separated from the body 12 in an at least one location via the wireless link 11. Not shown is the processor and non-transient computer storage medium. The processor is operable to process a first user-inputted combination or sequence of perceptibly identifiable entertainment media character picture representations and compare the first user-inputted combination with a second, pre-determined user-inputted or manufacturer-inputted combination or sequence of perceptibly identifiable entertainment media character picture representations stored in the non-transient computer storage medium. If the comparison returns an exact match, the shackle 14 is separated from the body 12 in the at least one location. Typical design and functionality architecture of the processor and non-transient computer storage medium is well known in the art.

The present invention has the advantage of providing a cost-effective form of brand awareness for the entertainment media franchise, licensees, and partners. By utilizing a particular entertainment media character picture representation combination-locking device in day-to-day life, e.g. to secure a bike at school every weekday morning, the user is more likely to discuss the entertainment media franchise and associated brands in day-to-day life and, considering the value-add of the combination locking-device, the dialogue engaged in with others is likely to be positive. Such “word-of-mouth” advertising is likely to persuade the user's trusted social and familial circles to investigate the entertainment media franchise and associated brands, licensees, and partners, which may lead to further significant sales and loyal customer followings at a low cost-of-customer-acquisition to the entertainment media franchise and associated brands, licensees and partners. Furthermore, the present invention may generally be placed in public and visible locations such as public bicycle racks and other public transport medium parking and securing locations. This creates a further avenue of no-cost brand awareness for the entertainment media franchise and associated brands, licensees and partners.

The present invention has the advantage of making the process of securing important items and objects fun and entertaining for children. By making the unlocking combination a plurality of character picture representations from a child or user's favorite entertainment media franchise, the child or user is more likely to not only make sure that important and potentially expensive items are secured, but are more likely to easily remember the unlocking combination comprising a plurality of entertainment media character picture representations, as opposed to an unlocking combination comprising a series or sequence of just numbers or letters with no deep meaning or association for the user. Combination locking devices incorporating unlocking codes with a child's favorite character picture representations from a particular entertainment media franchise means that parents and guardians do not have to stress about their child being negligent in securing important, and potentially expensive items, such as bicycles.

The present invention has the advantage of enabling an entertainment media franchise and its associated brands, licensees, licensors, and partners, to extend merchandising to an item used by millions of people in everyday life; an item unlikely to cease being essential for securing every day, and potentially expensive, items such as bicycles. Entertainment media franchises and their associated brands, licensees, licensors, and partners generally accrue the highest proportion of revenue from merchandise sales compared to direct entertainment media sales. Each corporation owning the rights to a particular entertainment media franchise is facing increasing competition from a plurality of corporations owning a plurality of other entertainment media franchises. Standing out in this competitive environment involves maintaining a fast-paced innovation cycle comprising innovative products that solve problems of consumers.

The present invention solves a major problem faced by consumers as has been previously highlighted in this specification.

Those skilled in the art may readily adopt one or more of the inventive aspects, concepts or features into additional embodiments and uses within the scope of the present invention even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A combination-locking apparatus comprising:
a body;
a locking mechanism coupled to the body;
a plurality of wheels operatively coupled to the locking mechanism and to the body;
a plurality of perceptibly identifiable entertainment media character picture representations;
wherein each of the wheels is rotatable relative to the body between a locked position wherein the locking mechanism is locked relative to the respective wheel, and an unlocked position wherein the locking mechanism is unlocked relative to the respective wheel;
wherein each wheel comprises a first perceptibly identifiable entertainment media character picture representation disposed upon at least a portion of the wheel's surface, and a second perceptibly identifiable entertainment media character picture representation disposed upon at least a portion of the wheel's surface; wherein the first entertainment media character picture representation and the second entertainment media character picture representation are spaced at an arbitrary relative distance; and
wherein the first perceptibly identifiable entertainment media character picture representation disposed upon at least the portion of the wheel's surface has a surface area at least greater than one two-hundredth of the wheel's total surface and further wherein the first perceptibly identifiable entertainment media character picture representation is not directly connected to the body; and
wherein an at least a portion of the plurality of perceptibly identifiable entertainment media character picture representations disposed upon at least a portion of the plurality of wheels are configured to display a first row of perceptibly identifiable entertainment media character picture representations relative to the body.

2. The apparatus of claim 1, wherein the plurality of perceptibly identifiable entertainment media character picture representations are derived from a single entertainment media franchise.

3. The apparatus of claim 1, wherein the plurality of perceptibly identifiable entertainment media character picture representations are derived from a plurality of entertainment media franchises.

4. The apparatus of claim 1, wherein each wheel is adapted to display only one perceptibly identifiable entertainment media character picture representations at any particular instance in time.

5. The apparatus of claim 1, wherein each wheel is adapted to display a plurality of perceptibly identifiable entertainment media character picture representations at any particular instance in time.

6. The apparatus of claim 1, wherein the total number of wheels is greater than four.

7. The apparatus of claim 1, wherein the total number of wheels is less than four.

8. The apparatus of claim 1, wherein the total number of wheels is equal to four.

9. The apparatus of claim 1, wherein the body has a physical structure substantially representative of a perceptibly identifiable entertainment media character picture representation.

10. A combination-locking apparatus comprising:
a body;
a locking mechanism coupled to the body;
an electronics device comprising a user-interfacing means;
wherein the electronics device is coupled to the locking mechanism;
wherein the electronics device is operable to, via the user-interfacing means, present a plurality of perceptibly identifiable entertainment media character picture representations; and
wherein each of the plurality of perceptibly identifiable entertainment media character picture representations is operable to occupy an interactive area of the user-interfacing means that is greater than one two-hundredth of the total interactive area of the user-interfacing means; and
wherein the electronics device is operable to decouple the locking mechanism from the body in an at least one location, wherein the electronics device registers a particular sequence of perceptibly identifiable entertainment media character picture representations.

11. The apparatus of claim 10, wherein the electronics device may include a smartphone, a tablet, a portable communications device, an audio input and output device, a motion sensor input and output device.

12. The apparatus of claim 10, wherein the user-interfacing means comprises a screen for displaying to a human user a plurality of human-interactive perceptibly identifiable entertainment media character picture representations.

13. The apparatus of claim 10, wherein the user-interfacing means comprises a human-interactive audio input and output system for relaying to a human user a plurality of perceptibly identifiable entertainment media character picture representations.

14. The apparatus of claim 10 further comprising:
a processor;
a non-transient computer storage medium coupled to the electronics device and operable to store the plurality of perceptibly identifiable entertainment media character picture representations, including an at least one unique sequence or combination of perceptibly identifiable entertainment media character picture representations, wherein the unique sequence is required to be inputted via the user-interfacing means and registered by the processor in order to decouple the locking mechanism from the body in the at least one location;
wherein the processor is coupled to the electronics device, wherein the processor is operable to facilitate decoupling of the locking mechanism from the locking body in the at least one location, wherein the processor compares a first user-inputted or user-selected sequence or combination of perceptibly identifiable entertainment media character picture representations via the user-interfacing means with a second unique sequence or combination of perceptibly identifiable entertainment media character picture representation previously stored in the non-transient computer storage medium, and the results of the comparison returns an exact match and;
wherein the user-interfacing means is operable to enable a user to select or input a unique sequence or combination of perceptibly identifiable entertainment media character picture representations, wherein the unique sequence is required to be inputted via the user-interfacing means and registered by the processor in order to decouple the unlocking mechanism from the body in the at least one location.

15. The apparatus of claim 14, wherein the processor is a microprocessor, controller, microcontroller, or central processing unit.

16. A method of manufacturing an entertainment media character picture representation combination locking device, the method comprising:
determining a plurality of perceptibly identifiable entertainment media character picture representations to be displayed by the locking device;
disposing a plurality of rotatable wheels at least partially within the locking device;
disposing an at least one perceptibly identifiable entertainment media character picture representation on an at least a portion of the surface of an at least one rotatable wheel such that the at least one perceptibly identifiable entertainment media character picture representation occupies a surface area at least greater than one two-hundredth of the surface area of the at least one rotatable wheel, and further disposing the at least one perceptibly identifiable entertainment media character picture representation on the at least the portion of the surface of the at least one rotatable wheel such that the at least one perceptibly identifiable entertainment media character picture representation does not directly connect with a main housing; and
arranging the plurality of rotatable wheels in a first position wherein in the first position an at least one of the plurality of rotatable wheels displays an at least one perceptibly identifiable entertainment media character picture representation.

17. The method of claim 16, wherein the total number of rotatable wheels is greater than four.

18. The method of claim 16, wherein the total number of rotatable wheels is less than four.

19. The method of claim 16, wherein the total number of rotatable wheels is equal to four.

20. A shackle-based combination locking device, the device comprising:
a body attached to a shackle in an at least one location;
a plurality of wheels, each wheel comprising a notch;
a bar coupled to the plurality of wheels, such that at particular instances in time the bar is inserted into all notches simultaneously, the action of which will allow the locking device to be decoupled from an at least one object it was previously serving its function of locking;
a human-interactive dial comprising a plurality of perceptibly identifiable entertainment media character picture representations disposed upon an at least a portion of the dial's surface such that each of the plurality of perceptibly identifiable entertainment media character picture representation s occupies a surface area at least greater than one two-hundredth of the dial's surface and further wherein each of the perceptibly identifiable entertainment media character picture representation is not directly connected to the shackle;
a spindle coupled to at least a portion of the plurality of wheels; and
wherein the plurality of wheels, the plurality of notches, the bar coupled to the plurality of wheels, the dial, the spindle, and the shackle attached to the body in the at least one location, in combination, comprises a locking mechanism operatively coupled to the body.

21. The device of claim 20, wherein the plurality of perceptibly identifiable entertainment media character picture representations is from a single entertainment media franchise.

22. The device of claim 20, wherein the plurality of perceptibly identifiable entertainment media character picture representations is from a plurality of entertainment media franchises.

23. The device of claim 20, wherein the plurality of perceptibly identifiable entertainment media character picture representations is greater than seven.

24. The device of claim 20, wherein the plurality of perceptibly identifiable entertainment media character picture representations is less than seven.

25. The device of claim 20, wherein the plurality of perceptibly identifiable entertainment media character picture representations is equal to seven.

26. The device of claim 20, wherein the body has a physical structure substantially representative of a perceptibly identifiable entertainment media character picture representation.
